(19) United States
(12) Patent Application Publication
(10) Pub. No.: US 2012/0225974 A1
(43) Pub. Date: Sep. 6, 2012

(54) RUBBER COMPOSITION FOR TIRE AND PNEUMATIC TIRE

(75) Inventors: Makoto Uno, Osaka-shi (JP); Shinya Hasegawa, Osaka-shi (JP)

(73) Assignee: TOYO TIRE & RUBBER CO., LTD., Osaka (JP)

(21) Appl. No.: 13/404,216

(22) Filed: Feb. 24, 2012

(30) Foreign Application Priority Data
Mar. 4, 2011 (JP) 2011-047869
May 12, 2011 (JP) 2011-107482

(51) Int. Cl. C08K 3/34; C08L 9/00; C08L 7/00; C08L 9/06; C08K 3/04; C08K 3/36

(52) U.S. Cl. 523/155

(57) ABSTRACT

A rubber composition for tire, comprising at least a rubber component and an inorganic filler, wherein the inorganic filler has an angle of repose of 40 degrees or more, a Mohs' hardness of 2.0 or less, a BET specific surface area (BETS) (m²/g) of 10 m²/g or more, and a ratio (DBP)/(BET5) of the amount (ml/100 g) of dibutyl phthalate (DBP) absorbed to the BET specific surface area (BET5) (m²/g) of 2.0 or more, and wherein the content of the inorganic filler is from 0.5 to 50 parts by mass based on 100 parts by mass of the rubber component.

### BACKGROUND OF THE INVENTION

1. Field of the Invention

The present invention relates to a rubber composition for tire, containing at least a rubber component and an inorganic filler, which has elastic modulus, flex fatigue performance and fracture resistance characteristics improved in good balance without causing deterioration of the rubber physical properties of a vulcanized rubber, and also can reduce rolling resistance by improving low heat generation performance, and a pneumatic tire.

2. Description of the Related Art

In general, examples of a technique in which the elastic modulus (hardness) and fracture resistance characteristics (breaking strength and tear strength) of a vulcanized rubber reinforced with reinforcing fillers such as carbon black and silica include a technique in which a special carbon black is used and a technique in which carbon black is partially substituted with silica. These techniques have a problem such as poor processing performance, for example, the viscosity of a rubber composition increases at the time of unvulcanization, although the effect of improving elastic modulus and fracture resistance characteristics is recognized. There has also been proposed, as a technique in which the processing performance of a rubber composition and the tear strength of a vulcanized rubber are improved, a technique in which a processing aid and a rosin-based resin are added. However, the elastic modulus and low heat generation performance of the vulcanized rubber deteriorate, and thus endurance and rolling resistance of a tire tend to increase (deteriorate).

The below-mentioned Patent Document 1 describes a technique in which, in the vulcanized rubber of a rubber composition for inner liner of a tire, talc having high flatness is blended in the rubber composition, together with predetermined carbon black, for the purpose of improving tear strength and flex fatigue performance while maintaining satisfactory airtight performance. According to such a technique, however, the tear strength and the flex fatigue performance are not sufficiently improved, although the airtight performance is improved. There is room for further improvement in this respect. The below-mentioned Patent Document 2 and Patent Document 3 also describe a rubber composition containing a porous inorganic filler or a layered clay mineral blended therein. However, specific characteristics are nor described therein such as the shape of the porous inorganic filler or layered clay mineral.

### PRIOR ART DOCUMENTS

[Patent Document 1] Published Japanese Translation No. 2008-528739 of the PCT Application
[Patent Document 2] Japanese Unexamined Patent Publication No. 2000-79807
[Patent Document 3] Japanese Unexamined Patent Publication No. 2008-189725

### SUMMARY OF THE INVENTION

### Problems to be Solved by the Invention

Under these circumstances, the present invention has been made and an object thereof is to provide a rubber composition for tire, which has elastic modulus, flex fatigue performance and fracture resistance characteristics improved in good balance without causing deterioration of the rubber physical properties of a vulcanized rubber, and also can reduce rolling resistance by improving low heat generation performance, and a pneumatic tire. Another object of the present invention is to provide a rubber composition for tire, which has high rubber hardness, high elastic modulus, cut/chipping performance, fracture resistance characteristics and abrasion performance improved in good balance, and also can reduce rolling resistance by improving low heat generation performance, and a pneumatic tire.

### Means for Solving the Problems

The above object can be achieved by the present invention described below. That is, the present invention relates to a rubber composition for tire, comprising at least a rubber component and an inorganic filler, wherein the inorganic filler has an angle of repose of 40 degrees or more, a Mohs' hardness of 2.0 or less, a BET specific surface area (BET5) (m²/g) of 10 m²/g or more, and a ratio (DBP)/(BET5) of the amount (ml/100 g) of dibutyl phthalate (DBP) absorbed to the BET specific surface area (BET5) (m²/g) of 2.0 or more, and wherein the content of the inorganic filler is from 0.5 to 50 parts by mass based on 100 parts by mass of the rubber component.

Since the above rubber composition for tire contains 0.5 to 50 parts by mass of an inorganic filler having specific flatness (an angle of repose), specified specific surface area (BET5), degree of development with a specific structure ((DBP)/(BET5)), and specific Mohs' hardness, elastic modulus, flex fatigue performance and fracture resistance characteristics are improved in good balance while satisfactorily maintaining the rubber physical properties of a vulcanized rubber, and also low heat generation performance is improved. With improvement in low heat generation performance, it becomes possible to reduce rolling resistance in a pneumatic tire using such a rubber composition.

In the above rubber composition for tire, it is preferred that the rubber component contains 30 to 90 parts by mass of a natural rubber or a polyisoprene rubber, 10 to 70 parts by mass a polystyrene-butadiene rubber, and 0 to 60 parts by mass of a polybutadiene rubber, in 100 parts by mass of the rubber component. When a tire tread is produced using a rubber composition containing such a rubber component as a raw material, it is possible to produce a pneumatic tire with a tire tread, which has high rubber hardness, high elasticity, cut/chipping performance, fracture resistance characteristics and abrasion performance improved in good balance, and also can reduce rolling resistance by improving low heat generation performance.

In the above rubber composition for tire, it is preferred that the inorganic filler is talc, and the content thereof is from 3 to 30 parts by mass based on the 100 parts by mass of the rubber component. With the constitution, the elastic modulus, fracture resistance characteristics, flex fatigue performance, flex fatigue performance and low heat generation performance of the vulcanized rubber are improved in better balance. Talc is a natural mineral and is available at low cost, and is preferable from the viewpoints of both environment and cost.

Preferably, the above rubber composition for tire further comprises a reinforcing filler comprised of at least one kind of carbon black and silica, wherein the content of the inorganic filler is less than that of the reinforcing filler. When the rubber composition contains the reinforcing filler comprised of at least one kind of carbon black and silica, together with the inorganic filler having specific flatness, degree of development with a specific structure, specified specific surface area and specific Mohs' hardness, the dispersion performance of the reinforcing filler in the rubber composition is improved by the influence of the inorganic filler as compared with the case of containing the reinforcing filler alone. Therefore, the elastic modulus, fracture resistance characteristics, flex fatigue performance, flex fatigue performance and low heat generation performance of the vulcanized rubber are particularly improved in good balance. The reason why the dispersion performance of the reinforcing filler is improved when using in combination with the inorganic filler is not apparent. However, it is supposed that, when the inorganic filler and the reinforcing filler are kneaded, together with the rubber component, the inorganic filler slips in a polymer of the rubber component, and thus the rubber component exerts a function of assisting the dispersion of the reinforcing filler in the polymer. In order to improve the elastic modulus, fracture resistance characteristics, flex fatigue performance and low heat generation performance of the vulcanized rubber in good balance while maintaining the processing performance of the rubber composition for tire, the content of the reinforcing filler is preferably from 30 to 150 parts by mass based on 100 parts by mass of the rubber component.

The present invention also relates to a pneumatic tire using the rubber composition for tire according to any one of the above rubber compositions for tire. The rubber physical properties, elastic modulus, flex fatigue performance and low heat generation performance of the pneumatic tire are improved in good balance.

In the above pneumatic tire, a pneumatic tire using the rubber composition for tire having rubber component contains 30 to 90 parts by mass of a natural rubber or a polyisoprene rubber, 10 to 70 parts by mass a polystyrene-butadiene rubber, and 0 to 60 parts by mass of a polybutadiene rubber, in 100 parts by mass of the rubber component. When a tire tread thereof is produced using a rubber composition containing such a rubber component as a raw material, it is possible to produce a pneumatic tire with a tire tread, which has high rubber hardness, high elasticity, cut/chipping performance, fracture resistance characteristics and abrasion performance improved in good balance, and also can reduce rolling resistance by improving low heat generation performance.

### BRIEF DESCRIPTION OF THE DRAWINGS

FIG. 1 is a side view showing an appliance for and a method of measuring the angle of repose and height (H) of an inorganic filler; and

FIG. 2 is a tire meridian sectional view showing one example of a pneumatic tire according to the present invention.

### DETAILED DESCRIPTION OF THE PREFERRED EMBODIMENTS

The rubber composition for tire according to the present invention contains at least a rubber component and an inorganic filler. In the present invention, it is preferred to contain a diene-based rubber as a rubber component.

Examples of the diene-based rubber include a natural rubber (NR), a polyisoprene rubber (IR), a styrene-butadiene rubber (SBR), a polybutadiene rubber (BR), a butadiene rubber containing syndiotactic-1,2-polybutadiene (SPB), a chloroprene rubber (CR), a nitrile rubber (NBR) and the like, and these rubbers can be respectively used alone, or used as a blend of two or more kinds of them. It is also possible to optionally use, as these diene-based rubbers described above, those whose terminal is modified (for example, terminal-modified BR, terminal-modified SBR, etc.), or those which are modified so as to impart desired characteristics (for example, modified NR). It is also possible to use, as the polybutadiene rubber (BR), those synthesized using a polymerization catalyst composition containing a metallocene complex described in WO 2007-129670, in addition to those synthesized using a cobalt (Co) catalyst, a neodymium (Nd) catalyst, a nickel (Ni) catalyst, a titanium (Ti) catalyst and a lithium (Li) catalyst.

In the present invention, in case of particularly using as a rubber composition for tire tread, it is preferred to contain, as the rubber component, 30 to 90 parts by mass of a natural rubber or a polyisoprene rubber, 10 to 70 parts by mass of a polystyrene-butadiene rubber and 0 to 60 parts by mass of a polybutadiene rubber in 100 parts by mass of the rubber component. In order to improve the abrasion performance, processing performance, tear performance and low heat generation performance in good balance, it is preferred to contain, as the rubber component, 40 to 80 parts by mass of a natural rubber or a polyisoprene rubber, 20 to 60 parts by mass of a polystyrene-butadiene rubber and 0 to 40 parts by mass of a polybutadiene rubber in 100 parts by mass of the rubber component.

In case of taking the low heat generation performance of the vulcanized rubber into consideration, the polystyrene-butadiene rubber is preferably a polystyrene-butadiene rubber in which the styrene content is from 10 to 40% by mass, the vinyl bond content of the butadiene moiety is from 10 to 70% by mass, and the cis component is 10% by mass or more, and particularly preferably a polystyrene-butadiene rubber in which the styrene content from 15 to 25% by mass, the vinyl bond content of the butadiene moiety is from 10 to 60% by mass, and the cis component is 20% by mass or more. In case of using as a tread rubber portion of a pneumatic tire, a non-oil extended polystyrene-butadiene rubber is preferably used as compared with an oil-extended polystyrene-butadiene rubber.

In order to improve the abrasion performance, processing performance, tear performance and low heat generation performance in good balance, it is preferred to blend a polybutadiene rubber having a mass average molecular mass of 350,000 to 1,000,000 in the rubber composition, and particularly preferred to blend a polybutadiene rubber having a mass average molecular mass of 350,000 to 1,000,000 and also having a cis-1,4 content of 95% or more.

When the rubber composition is used for tire tread (in case of a rubber composition for tire tread), the rubber composition may contain, as the rubber component, a natural rubber (NR), a polyisoprene rubber (IR), a polystyrene-butadiene rubber (SBR), and a diene-based rubber other than the polybutadiene rubber (BR) as long as the effects of the present invention are not impaired. Examples of the diene-based rubber include a chloroprene rubber (CR), a nitrile rubber (NBR) and the like, and these diene-based rubbers can be used alone, or used as a blend of two or more kinds of them. It is also possible to use, as these rubbers, those whose terminal is modified, or those which are modified so as to impart desired characteristics. In case of a synthetic rubber, there is no particular limitation on the polymerization method, molecular mass and the like, and a combination of the kind of rubbers and a blending ratio can be appropriately selected.

The rubber composition for tire according to the present invention contains, in addition to the rubber component, an inorganic filler having an angle of repose of 40 degrees or more, a Mohs' hardness of 2.0 or less, a BET specific surface area (BET5) of 10 m²/g or more, and a ratio (DBP)/(BET5) of the amount (ml/100 g) of dibutyl phthalate (DBP) absorbed to the BET specific surface area (BET5) (m²/g) of 2.0 or more. When the angle of repose of the inorganic filler is less than 40 degrees, since an aspect ratio is too high or a particle diameter is too large, the fracture resistance characteristics of the vulcanized rubber deteriorate. The Mohs' hardness of the inorganic filler of more than 2 may cause deterioration of the dispersion performance in the rubber and stress concentration, resulting in deterioration of the fracture resistance characteristics and the low heat generation performance. Furthermore, when (DBP)/(BET5) is less than 2, sufficient reinforcing effect cannot be obtained and thus the elastic modulus decreases. In order to improve the elastic modulus and fracture resistance characteristics of the vulcanized rubber in good balance and to improve the low heat generation performance, the inorganic filler preferably has an angle of repose of 42 degrees or more, a Mohs' hardness of 1 or less, a BET5 of 10 m²/g or more, and/or a (DBP)/(BET5) of 3.0 or more. For example, the upper limit of the angle of repose is 50 degrees or less, the upper limit of the BET5 is 30 m²/g or less, and/or the upper limit of the (DBP)/(BET5) is 10 or less.

The angle of repose of the inorganic filler can be measured by the following method.

### (Appliance for and Method of Measuring Angle of Repose and Height (H) of Inorganic Filler)

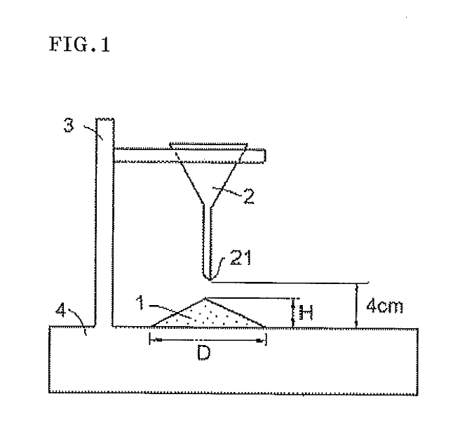

As shown in FIG. 1, 10 g of a powder sample 1, a funnel 2 made of reinforced glass (diameter of 45 mm, leg inner diameter of 5 mm, full length of 90 mm, leg length of 45 mm), a funnel stand 3 which supports to fix the funnel 2, and a rubber stopper for blocking an outlet 21 of the lower end of the leg of the funnel 2 are used. The height from a horizontal base plate 4 to the outlet 21 of the funnel 2 becomes 4 cm by adjusting the height of the funnel stand 3. After pouring 10 g of the powder sample in the funnel made of glass in a state where the outlet 21 of the funnel 2 is blocked with the rubber stopper, the rubber stopper is gently drawn. After confirming that the powder sample 1 is accumulated on the horizontal base plate 4 in the form of a mountain having a nearly accurate conical shape, the height (H) and diameter (D) of this mountain having a conical shape are measured. Based on this measurement, “angle of repose” (degrees) is determined by the following equation (1):

tan(angle of repose)=H/(D/2) (1)

In the inorganic filler used in the present invention, the smaller the angle of repose measured by the above method, the higher the flatness becomes (high flatness). When the high flatness inorganic filler is blended in the rubber composition, the flex fatigue performance and the fracture resistance characteristics particularly deteriorate. Similarly, the lower the height (H) measured by the above method, the higher the degree of flatness of the inorganic filler becomes (high flatness). Therefore, when the low flatness inorganic filler having a height (H) measured by the above method of 30 mm or more is blended in the rubber composition, the flex fatigue performance and fracture resistance characteristics of the vulcanized rubber are particularly improved, preferably.

The content of the inorganic filler in the rubber composition for tire according to the present invention is set within a range from 0.5 to 50 parts by mass based on 100 parts by mass of the rubber component. It is possible to improve the elastic modulus, fracture resistance characteristics, flex fatigue performance and low heat generation performance of the vulcanized rubber in good balance by setting the content of the inorganic filler within the above range. In order to improve the physical properties of the vulcanized rubber in better balance, it is preferred to adjust the content of the inorganic filler within a range from 3 to 30 parts by mass based on 100 parts by mass of the rubber component.

When the rubber composition for tire according to the present invention is used as the rubber composition for tire tread, the content of the inorganic filler in the rubber composition is set within a range from 0.5 to 30 parts by mass based on 100 parts by mass of the rubber component. It is possible to improve the elastic modulus, cut/chipping performance, fracture resistance characteristics and low heat generation performance of the vulcanized rubber in good balance by setting the content of the inorganic filler within the above range. In order to improve the physical properties of the vulcanized rubber in better balance, it is preferred to adjust the content of the inorganic filler within a range from 2 to 20 parts by mass based on 100 parts by mass of the rubber component.

Examples of the inorganic filler include talc. When talc is used as the inorganic filler, the elastic modulus, fracture resistance characteristics, flex fatigue performance and low heat generation performance of the vulcanized rubber are improved in good balance.

Talc is an inorganic powder obtained by finely grinding ores such as natural talc, and contains hydrous magnesium silicate [Mg₃Si₄O₁₀(OH)₂] as a main component. In the present invention, commercially available talcs can also be suitably used. For example, it is possible to suitably use “MISTRON VAPOR RE” (angle of repose of 44 degrees, Mohs' hardness of 1, (BET5) of 13.4 m²/g, (DBP)/(BET5) of 3.7), manufactured by NIHON MISTRON CO., LTD., “P-6” (angle of repose of 44 degrees, Mohs' hardness of 1, (BET5) of 10.5 m²/g, (DBP)/(BET5) of 4.3) manufactured by Nippon Talc Co., Ltd., and the like.

In the present invention, at least one kind of carbon black and silica is used as the reinforcing filler. It is possible to use, as carbon black, conductive carbon black such as acetylene black or ketjen black, in addition to conventional carbon black used in the rubber industry, such as SAF, ISAF, HAF, FEF or GPF. Examples of the silica include wet silica, dry silica, colloidal silica, precipitated silica and the like. It is particularly preferable to use wet silica containing hydrous silicic acid as a main component. In order to improve the elastic modulus, fracture resistance characteristics, flex fatigue performance and low heat generation performance of the vulcanized rubber in good balance while maintaining the processing performance of the rubber composition, the content of the inorganic filler is preferably less than that of the reinforcing filler. The content of the inorganic filler is more preferably from 30 to 150 parts by mass, and particularly preferably from 30 to 80 parts by mass, based on 100 parts by mass of the rubber component.

When the rubber composition for tire according to the present invention is used as a rubber composition for tire tread, the content of the reinforcing filler is preferably from 40 to 65 parts by mass, and more preferably from 45 to 65 parts by mass, based on 100 parts by mass of the rubber component so as to improve the elastic modulus, cut/chipping performance, fracture resistance characteristics and low heat generation performance of the vulcanized rubber in good balance. Particularly, when a cap tread at the thread side of a pneumatic tire is produced using the rubber composition according to the present invention, it is preferable that hard carbon having abrasion performance (carbon black of HAF or more) is used as the reinforcing filler, and also the amount of carbon black blended is adjusted to 80% by mass or more. Furthermore, when silica is used, it is preferred to blend a silane coupling agent in an amount of 5 to 15% by mass based on the content of silica.

In the rubber composition according to the present invention, when using as a raw material of a tire member to which adhesion is required, a methylene receptor and a methylene donor may be blended. It is possible to enhance adhesion performance with other members when a hydroxyl group of the methylene receptor and a methylene group of the methylene donor undergo a curing reaction.

It is possible to use, as the methylene receptor, a compound of phenols, or a phenol-based resin obtained by condensing the compound of phenols with formaldehyde. Examples of the compound of phenols include phenol, resorcin and an alkyl derivative thereof. Examples of the alkyl derivative include methyl group derivatives such as cresol and xylenol, and derivatives obtained by a long chain alkyl group such as nonylphenol and octylphenol. The compound of phenols may have an acyl group such as an acetyl group as a substituent.

Examples of the phenol-based resin obtained by condensing the compound of phenols with formaldehyde include a resorcin-formaldehyde resin, a phenol resin (phenol-formaldehyde resin), a cresol resin (cresol-formaldehyde resin), a formaldehyde resin comprised of a plurality of compounds of phenols, and the like. These resins are uncured resins, and those having liquid or thermal fluidity are used.

Among these, the methylene receptor is preferably resorcin or a resorcin derivative, and particularly preferably resorcin or a resorcin-alkylphenol-formalin resin, from the viewpoints of compatibility with the rubber component and other components, denseness of the resin after curing, and reliability. The amount of these compounds of phenols or phenol-based resin blended is preferably from 0.1 to 10 parts by mass, and more preferably from 0.5 to 5 parts by mass, based on 100 parts by mass of the rubber component.

Hexamethylenetetramine or a melamine derivative is used as the above methylene donor. Examples of the melamine derivative to be used include ethylolmelamine, a partially etherified product of methylolmelamine, a condensate of melamine, formaldehyde and methanol, and the like. Among the melamine derivative, hexamethoxymethylmelamine is particularly preferable. The amount of the hexamethylenetetramine or the melamine derivative blended is preferably from 0.1 to 10 parts by mass, and more preferably from 0.5 to 5 parts by mass, based on 100 parts by mass of the rubber component.

In the rubber composition according to the present invention, when using as a raw material of a tire member to which adhesion is required, an organic acid metal salt may be blended in the rubber composition. Examples of the organic acid metal salt include cobalt naphthenate, cobalt stearate, cobalt borate, cobalt oleate, cobalt maleate, cobalt borate neodecanoate and the like.

The amount of the above organic acid metal salt blended is preferably from 0.03 to 0.40 parts by mass, and more preferably from 0.05 to 0.2 parts by mass, in terms of the metal content based on 100 parts by mass of the rubber component. When the amount of the organic acid metal salt blended is less than 0.03 parts by mass in terms of the metal content, initial adhesion performance with other members such as a reinforcing cord may become insufficient. Even if the amount exceeds 0.40 parts by mass, it is difficult to obtain the effect of further improving adhesion performance, resulting in high cost.

The rubber composition according to the present invention can be used after appropriately blending compound agents used usually in the rubber industry, for example, methylene receptors and methylene donors, organic acid metal salts, sulfur, silane-based coupling agents, zinc white, stearic acid, vulcanization accelerators, auxiliary vulcanization accelerators, vulcanization retarders, anti-aging agents, softeners such as wax and oil, and processing aids, together with the above rubber components, inorganic fillers and reinforcing fillers as long as the effects of the present invention are not impaired.

Sulfur may be sulfur for conventional rubber and, for example, powdered sulfur, precipitated sulfur, insoluble sulfur, highly dispersible sulfur and the like can be used. Taking rubber physical properties, durable performance and the like after vulcanization into consideration, the amount of sulfur blended is preferably from 0.5 to 15 parts by mass in terms of the sulfur content based on 100 parts by mass of the rubber component.

It is possible to use, as the vulcanization accelerator, vulcanization accelerators used usually for rubber vulcanization, such as sulfeneamide-based vulcanization accelerators, thiuram-based vulcanization accelerators, thiazole-based vulcanization accelerators, thiourea-based vulcanization accelerators, guanidine-based vulcanization accelerators and dithiocarbamate-based vulcanization accelerators alone, or in combination appropriately. In case of taking rubber physical properties and durable performance after vulcanization into consideration, the amount of the vulcanization accelerator blended is preferably from 0.1 to 10 parts by mass, based on 100 parts by mass of the rubber component.

It is possible to use, as the anti-aging agent, anti-aging agents used usually for rubber, such as aromatic amine-based anti-aging agents, amine-ketone-based anti-aging agents, monophenol-based anti-aging agents, bisphenol-based anti-aging agents, polyphenol-based anti-aging agents, dithiocarbamate-based anti-aging agents and thiourea-based anti-aging agents alone, or in combination appropriately. In case of taking rubber physical properties and durable performance into consideration, the amount of the anti-aging agent blended is preferably from 0 to 15 parts by mass, based on 100 parts by mass of the rubber component.

The rubber composition according to the present invention can be obtained by kneading the above rubber components, inorganic fillers, reinforcing fillers and, optionally, compound agents used usually in the rubber industry, for example, methylene receptors and methylene donors, organic acid metal salts, sulfur, silane-based coupling agents, zinc white, stearic acid, vulcanization accelerators, auxiliary vulcanization accelerators, vulcanization retarders, anti-aging agents, softeners such as wax and oil, and processing aids, using conventional kneaders used in rubber industry, such as a Banbury mixer, a kneader and a roll.

There is no particular limitation on a method of blending the above respective components, and the method may be any of a method in which blending components other than vulcanization components such as sulfur and vulcanization accelerator are kneaded in advance to form a master batch and then the remaining components are added, followed by kneading; a method in which only rubber components and carbon black are formed into a kneaded master batch in advance and then the remaining components are added, followed by kneading; a method in which the respective components are added in optional order, followed by kneading; and a method in which all component are simultaneously added and then kneaded. When rubber components and carbon black are formed into a master batch in advance, a wet master batch obtained by mixing carbon black in a rubber latex may be used.

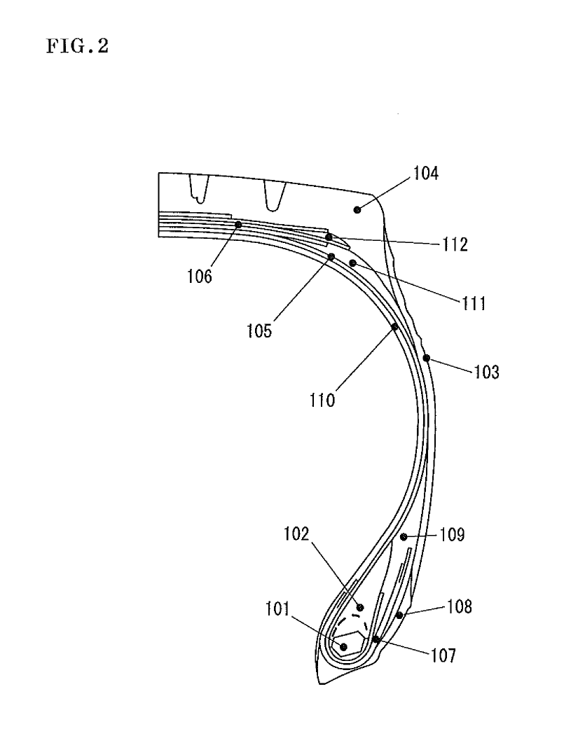

As shown in FIG. 2, a pneumatic tire according to the present invention includes a pair of bead wires 101; a bead filler 102 arranged at an outer side in the tire radial direction of the bead wires 101; a side wall 103 which extends from the bead wires 101 and the bead filler 102, respectively, to an outer side in the tire radial direction; a tread 104 which continues to each outer side end in the tire radial direction of the side wall 103; a carcass ply 105 in which an end side is wound up toward outside at a pair of the bead wires 101 from an inner side in the tire width direction; and a belt 106 comprised of a plurality of belt plies arranged at an outer circumference side (at an outer side in the tire radial direction) of the carcass ply 105. The tread 104 may be comprised of a single rubber portion, or may be comprised of two layers of a cap tread at the tread side and a base tread at an inner side in the tire radial direction.

A chafer 107 and a rim strip 108 are arranged at an inner side in the tire radial direction of the bead wire 101 and the bead filler 102 through the carcass ply 105, and are seated so that the rim strip 108 is in contact with a tire rim (not shown). A chafer pad 109 is arranged at an outer side in the tire radial direction of the bead filler 102 so as to sandwich the chafer 107. An inner liner 110 is arranged at the internal circumference side of the carcass ply 105 so as to retain pneumatic pressure. Also, a shoulder pad 111 is arranged at an inner side in the tire radial direction at the end side of the belt 106, and a belt edge filler 112 is arranged between ends of the plurality of belt plies.

Using the rubber composition according to the present invention, at least one position of the member is produced by a known device such as an extruder for rubber and an unvulcanized tire including the same is formed, and then the unvulcanized tire is vulcanized by a known method, whereby, it is possible to produce a pneumatic tire in which the elastic modulus, flex fatigue performance and fracture resistance characteristics are improved in good balance and rolling resistance is reduced by improving low heat generation performance.

Using the rubber composition according to the present invention for tire tread, the tread 104 is produced by a known device such as an extruder for rubber and an unvulcanized tire including the same is formed, and then the unvulcanized tire is vulcanized by a known method, and thus a pneumatic tire can be produced. As mentioned above, the vulcanized rubber of the rubber composition for tire tread according to the present invention is excellent in high rubber hardness, high elastic modulus, cut/chipping performance, fracture resistance characteristics and low heat generation performance, and is therefore particularly useful as a cap tread at the thread side. In case of using for a cap tread, for example, it becomes possible to reduce the rolling resistance of a pneumatic tire. In case of partitioning the land portion of a block or the like by groove portions such as a major groove and/or a lateral groove, it becomes possible to increase the depth of the groove portion. As a result, abrasion life of the tire is improved.

### EXAMPLES

Examples, which specifically illustrate the effect and constitution of the present invention, and the like will be described below. Evaluation items in the examples were evaluated under the below-mentioned evaluation conditions, using rubber samples obtained by heating the respective compositions at 150° C. for 30 minutes, followed by vulcanization.

(1) Processing performance of Rubber Composition

In accordance with JIS K6300, Mooney viscosity (ML 1+4) was measured at 100° C. The measured values of Examples 1 to 5 and Comparative Examples 1 to 10 were compared with the measured value of Comparative Example 1, the measured values of Examples 6 to 9 and Comparative Examples 11 to 13 were compared with the measured value of Comparative Example 11, and the measured values of Examples 10 to 13 and Comparative Examples 14 to 16 were compared with the measured value of Comparative Example 14. Those having the same or more excellent measured value were rated “Good”, whereas, those having inferior measured value were rated “Poor”.

### (2) Rubber Hardness

In accordance with JIS K6253, rubber hardness (durometer type A) at 23° C. was evaluated.

### (3) Breaking Strength (Fracture Resistance Characteristics)

In accordance with JIS K6251, a sample was made using dumbbell No. 3 and a tensile test was carried out. The breaking strength (MPa) at the time of breakage of the sample was measured. It means that the larger the breaking strength, the more fracture resistance characteristics are satisfactory.

### (4) Elongation at Break (%)

In accordance with JIS K6251, a sample was made using dumbbell No. 3 and a tensile test was carried out. The elongation at break (%) at the time of breakage of the sample was measured. It means that the larger the elongation at break, the more fracture resistance characteristics are satisfactory.

### (5) Flex Fatigue Performance

In accordance with JIS K6260, the measurement was carried out. The measured values of Examples 1 to 5 and Comparative Examples 1 to 10 were compared with the measured value of Comparative Example 1, the measured values of Examples 6 to 9 and Comparative Examples 11 to 13 were compared with the measured value of Comparative Example 11, and the measured values of Examples 10 to 13 and Comparative Examples 14 to 16 were compared with the measured value of Comparative Example 14. Those having the same or more excellent measured value were rated “Good”, whereas, those having inferior measured value were rated “Poor”.

### (6) Low Heat Generation Performance (Tan δ)

Using a viscoelastic spectrometer manufactured by UBM, the evaluation was carried out based on the tan δ value measured at an initial strain of 15%, a dynamic strain of ±2.5%, a frequency of 10 Hz and a temperature of 60° C. The evaluation results of Examples 1 to 5 and Comparative Examples 1 to 10 are shown by indexes, assuming the measured value of Comparative Example 1 to be 100, the evaluation results of Examples 6 to 9 and Comparative Examples 11 to 13 are shown by indexes, assuming the measured value of Comparative Example 11 to be 100, and the evaluation results of Examples 10 to 13 and Comparative Examples 14 to 16 are shown by indexes, assuming the measured value of Comparative Example 14 to be 100. It means that the smaller the numerical value, the more low heat generation performance is excellent.

### (Preparation of Rubber Composition)

According to the formulations shown in Table 1 to Table 3, rubber compositions of Example 1 to 13 and Comparative Example 1 to 16 were blended and then kneaded using a conventional Banbury mixer to prepare rubber compositions. The respective compound agents described in Table 1 to Table 3 are shown below (in Table 1 to Table 3, the amount of each compound agent blended is shown by the number of parts by mass based on 100 parts by mass of the rubber component). The angle of repose, height (H) (height (H) measured by the “method of measuring the angle of repose and height (H) of an inorganic filler), specific surface area (BET5), degree of development of structure ((DBP)/(BET5)) and Mohs' hardness of the following inorganic fillers (A) to (F) are shown in Table 4.

(a) Rubber component

Natural rubber (NR) “RSS#3”

Styrene-butadiene rubber (SBR) “SBR1723 (styrene content of 23.5%, 37.5% oil-extended”

Polybutadiene rubber (BR) “BR150L, manufactured by Ube Industries, Ltd.

(b) Carbon black

Carbon black (HAF) “SEAST 300”, manufactured by TOKAI CARBON CO., LTD.

Carbon black (SAF) “SEAST 9”, manufactured by TOKAI CARBON CO., LTD.

(c) Silica “Nipsil AQ”, manufactured by Nippon Silica Co., Ltd.
(d) Rosin resin, China rosin, manufactured by Arakawa Chemical Industries, Ltd.
(e) Processing aid “Aktiplast PP”, manufactured by Rhein Chemie Rheinau GmbH
(f) Inorganic filler

Inorganic filler (A) “MISTRON VAPOR RE”, manufactured by NIHON MISTRON CO., LTD.

Inorganic filler (B) “P-6”, manufactured by Nippon Talc Co., Ltd.

Inorganic filler (C) “SW”, manufactured by Nippon Talc Co., Ltd.

Inorganic filler (D) “HAR”, manufactured by NIHON MISTRON CO., LTD.

Inorganic filler (E) “HAKUENKA CC”, manufactured by Shiraishi Kogyo Kaisha, Ltd.

Inorganic filler (F) “Hard Clay”, manufactured by Shiraishi Kogyo Kaisha, Ltd.

(g) Zinc white “Zinc White No. 1”, (manufactured by MITSUI MINING & SMELTING., LTD.)
(h) Stearic acid, manufactured by NOF CORPORATION
(i) Sulfur, manufactured by TSURUMI CHEMICAL INDUSTRY CO., LTD.
(j) Vulcanization accelerator

Vulcanization accelerator TBBS “SANCELER NS-G”, manufactured by SANSHIN CHEMICAL INDUSTRY CO., LTD.

Vulcanization accelerator CBS “SANCELER CM-G”, manufactured by SANSHIN CHEMICAL INDUSTRY CO., LTD.

Vulcanization accelerator DPG “SOXINOL D-G”, manufactured by Sumitomo Chemical Co., Ltd.

(k) Silane coupling agent “Si75”, manufactured by Degussa

TABLE 1

| | Comparative | Comparative | Comparative | Comparative | Comparative | Comparative | Comparative | Comparative |
|---|---|---|---|---|---|---|---|---|
| | Example 1 | Example 2 | Example 3 | Example 4 | Example 5 | Example 6 | Example 7 | Example 8 |
| NR | 100 | 100 | 100 | 100 | 100 | 100 | 100 | 100 |
| Carbon black (HAF) | 40 | — | 30 | 40 | 45 | 40 | 40 | 40 |
| Carbon black (SAF) | — | 40 | — | — | — | — | — | — |
| Silica | — | — | 15 | — | — | — | — | — |
| Rosin resin | — | — | — | 10 | — | — | — | — |
| Processing aid | — | — | — | — | 3 | — | — | — |
| Inorganic filler (A) | — | — | — | — | — | 60 | — | — |
| Inorganic filler (B) | — | — | — | — | — | — | — | — |
| Inorganic filler (C) | — | — | — | — | — | — | 10 | — |
| Inorganic filler (D) | — | — | — | — | — | — | — | 10 |
| Inorganic filler (E) | — | — | — | — | — | — | — | — |
| Inorganic filler (F) | — | — | — | — | — | — | — | — |
| Zinc white | 3 | 3 | 3 | 3 | 3 | 3 | 3 | 3 |
| Stearic acid | 2 | 2 | 2 | 2 | 2 | 2 | 2 | 2 |
| Sulfur | 1.5 | 1.5 | 1.5 | 1.5 | 1.5 | 1.5 | 1.5 | 1.5 |
| Vulcanization | 1.5 | 1.5 | 1.5 | 1.5 | 1.5 | 1.5 | 1.5 | 1.5 |
| accelerator TBBS | | | | | | | | |
| Processing | (Basis) | Poor | Poor | Good | Good | Poor | Good | Good |
| performance | | | | | | | | |
| (based on | | | | | | | | |
| Comparative | | | | | | | | |
| Example 1) | | | | | | | | |
| Rubber hardness | 58 | 56 | 61 | 56 | 59 | 64 | 59 | 60 |
| Breaking strength | 29.1 | 30.8 | 32.3 | 28.4 | 30.3 | 27.9 | 28.6 | 27.9 |
| (MPa) | | | | | | | | |
| Elongation at | 450 | 480 | 470 | 500 | 440 | 360 | 410 | 360 |
| break (%) | | | | | | | | |
| Flex fatigue | (Basis) | Good | Good | Good | Good | Poor | Poor | Poor |
| performance | | | | | | | | |
| (based on | | | | | | | | |
| Comparative | | | | | | | | |
| Example 1) | | | | | | | | |
| tan δ | 100 | 110 | 92 | 111 | 114 | 109 | 99 | 101 |

| | Comparative | Comparative | Example | Example | Example | Example | Example |
|---|---|---|---|---|---|---|---|
| | Example 9 | Example 10 | 1 | 2 | 3 | 4 | 5 |
| NR | 100 | 100 | 100 | 100 | 100 | 100 | 100 |
| Carbon black (HAF) | 40 | 40 | 40 | 40 | 30 | 40 | 40 |
| Carbon black (SAF) | — | — | — | — | — | — | — |
| Silica | — | — | — | — | — | — | — |
| Rosin resin | — | — | — | — | — | — | — |
| Processing aid | — | — | — | — | — | — | — |
| Inorganic filler (A) | — | — | 5 | 10 | 10 | 30 | — |
| Inorganic filler (B) | — | — | — | — | — | — | 10 |
| Inorganic filler (C) | — | — | — | — | — | — | — |
| Inorganic filler (D) | — | — | — | — | — | — | — |
| Inorganic filler (E) | 10 | — | — | — | — | — | — |
| Inorganic filler (F) | — | 10 | — | — | — | — | — |
| Zinc white | 3 | 3 | 3 | 3 | 3 | 3 | 3 |
| Stearic acid | 2 | 2 | 2 | 2 | 2 | 2 | 2 |
| Sulfur | 1.5 | 1.5 | 1.5 | 1.5 | 1.5 | 1.5 | 1.5 |
| Vulcanization | 1.5 | 1.5 | 1.5 | 1.5 | 1.5 | 1.5 | 1.5 |
| accelerator TBBS | | | | | | | |
| Processing | Poor | Good | Good | Good | Good | Good | Good |
| performance | | | | | | | |
| (based on | | | | | | | |
| Comparative | | | | | | | |
| Example 1) | | | | | | | |
| Rubber hardness | 59 | 60 | 60 | 60 | 58 | 62 | 60 |
| Breaking strength | 27.2 | 27.6 | 31.0 | 31.2 | 28.8 | 30.5 | 30.9 |
| (MPa) | | | | | | | |
| Elongation at | 400 | 410 | 460 | 490 | 510 | 440 | 480 |
| break (%) | | | | | | | |
| Flex fatigue | Poor | Poor | Good | Good | Good | Good | Good |
| performance | | | | | | | |
| (based on | | | | | | | |
| Comparative | | | | | | | |
| Example 1) | | | | | | | |
| tan δ | 118 | 105 | 100 | 101 | 88 | 103 | 100 |

As is apparent from the results of Table 1, it is apparent that, in the vulcanized rubbers of the rubber compositions for tire according to Examples 1 to 5, the elastic modulus, flex fatigue performance and fracture resistance characteristics are improved in good balance and also the low heat generation performance is improved. On the other hand, in the vulcanized rubber of the rubber composition containing carbon black having a small particle diameter blended therein according to Comparative Example 2, the processing performance and low heat generation performance deteriorated. In the vulcanized rubber of the rubber composition containing carbon black and silica blended therein according to Comparative Example 3, the processing performance drastically deteriorated. In the vulcanized rubber of the rubber composition containing a rosin resin blended therein according to Comparative Example 4, the low heat generation performance deteriorated. Also in the vulcanized rubber of the rubber composition containing a processing aid blended therein according to Comparative Example 5, the low heat generation performance deteriorated.

In the vulcanized rubber of the rubber composition containing low flatness talc blended therein in a large amount according to Comparative Example 6, the fracture resistance characteristics and flex fatigue performance deteriorated. In the vulcanized rubber of the rubber composition containing talc having a large specific surface area and a large particle diameter blended therein according to Comparative Example 7, the flex fatigue performance deteriorated. In the vulcanized rubber of the rubber composition containing high flatness talc blended therein according to Comparative Example 8, the fracture resistance characteristics and flex fatigue performance deteriorated.

In the vulcanized rubber of the rubber composition containing calcium carbonate blended therein according to Comparative Example 9, the fracture resistance characteristics, flex fatigue performance and low heat generation performance deteriorated since the high Mohs' hardness of calcium carbonate can cause deterioration of the dispersion performance of calcium carbonate and carbon black in rubber and stress concentration. In the vulcanized rubber of the rubber composition containing clay blended therein according to Comparative Example 10, the fracture resistance characteristics and flex fatigue performance deteriorated because of high flatness of clay.

TABLE 2

| | Comparative | Comparative | Comparative | Example | Example | Example | Example |
|---|---|---|---|---|---|---|---|
| | Example 11 | Example 12 | Example 13 | 6 | 7 | 8 | 9 |
| SBR | 137.5¹⁾ | 137.5¹⁾ | 137.5¹⁾ | 137.5¹⁾ | 137.5¹⁾ | 137.5¹⁾ | 137.5¹⁾ |
| Carbon black (HAF) | 20 | 20 | 25 | 20 | 20 | 20 | 20 |
| Silica | 70 | 70 | 70 | 70 | 70 | 70 | 70 |
| Rosin resin | — | 10 | — | — | — | — | — |
| Processing aid | — | — | 3 | — | — | — | — |
| Inorganic filler (A) | — | — | — | 5 | 10 | 30 | — |
| Inorganic filler (B) | — | — | — | — | — | — | 10 |
| Inorganic filler (C) | — | — | — | — | — | — | — |
| Inorganic filler (D) | — | — | — | — | — | — | — |
| Inorganic filler (E) | — | — | — | — | — | — | — |
| Inorganic filler (F) | — | — | — | — | — | — | — |
| Silane coupling agent | 7 | 7 | 7 | 7 | 7 | 7 | 7 |
| Zinc white | 3 | 3 | 3 | 3 | 3 | 3 | 3 |
| Stearic acid | 2 | 2 | 2 | 2 | 2 | 2 | 2 |
| Sulfur | 2 | 2 | 2 | 2 | 2 | 2 | 2 |
| Vulcanization | 2 | 2 | 2 | 2 | 2 | 2 | 2 |
| accelerator CBS | | | | | | | |
| Vulcanization | 1 | 1 | 1 | 1 | 1 | 1 | 1 |
| accelerator DPG | | | | | | | |
| Processing | (Basis) | Good | Good | Good | Good | Good | Good |
| performance | | | | | | | |
| (based on | | | | | | | |
| Comparative | | | | | | | |
| Example 11) | | | | | | | |
| Rubber hardness | 60 | 57 | 59 | 62 | 62 | 64 | 62 |
| Breaking strength | 20.1 | 19.5 | 19.6 | 22.0 | 22.3 | 21.4 | 22.5 |
| (MPa) | | | | | | | |
| Elongation at | 420 | 450 | 430 | 430 | 440 | 420 | 440 |
| break (%) | | | | | | | |
| Flex fatigue | (Basis) | Good | Good | Good | Good | Good | Good |
| performance | | | | | | | |
| (based on | | | | | | | |
| Comparative | | | | | | | |
| Example 11) | | | | | | | |
| tan δ | 100 | 118 | 112 | 96 | 92 | 95 | 95 |

37.5% oil-extended product was used as SBR (amount of rubber component is 100 parts by mass)

As is apparent from the results of Table 2, it is apparent that, in the vulcanized rubbers of the rubber compositions for tire according to Examples 6 to 9, the elastic modulus, flex fatigue performance and fracture resistance characteristics are improved in good balance and also the low heat generation performance is improved. On the other hand, in the vulcanized rubber of the rubber composition containing a rosin resin blended therein according to Comparative Example 12, the low heat generation performance deteriorated. Also in the vulcanized rubber of the rubber composition containing a processing aid blended therein according to Comparative Example 13, the low heat generation performance deteriorated.

TABLE 3

| | Comparative | Comparative | Comparative | Example | Example | Example | Example |
|---|---|---|---|---|---|---|---|
| | Example 14 | Example 15 | Example 16 | 10 | 11 | 12 | 13 |
| NR | 70 | 70 | 70 | 70 | 70 | 70 | 70 |
| BR | 30 | 30 | 30 | 30 | 30 | 30 | 30 |
| Carbon black (SAF) | 45 | 45 | 50 | 45 | 45 | 45 | 45 |
| Rosin resin | — | 10 | — | — | — | — | — |
| Processing aid | — | — | 3 | — | — | — | — |
| Inorganic filler (A) | — | — | — | 5 | 10 | 30 | — |
| Inorganic filler (B) | — | — | — | — | — | — | 10 |
| Inorganic filler (C) | — | — | — | — | — | — | — |
| Inorganic filler (D) | — | — | — | — | — | — | — |
| Inorganic filler (E) | — | — | — | — | — | — | — |
| Inorganic filler (F) | — | — | — | — | — | — | — |
| Zinc white | 3 | 3 | 3 | 3 | 3 | 3 | 3 |
| Stearic acid | 2 | 2 | 2 | 2 | 2 | 2 | 2 |
| Sulfur | 1.5 | 1.5 | 1.5 | 1.5 | 1.5 | 1.5 | 1.5 |
| Vulcanization | 1.5 | 1.5 | 1.5 | 1.5 | 1.5 | 1.5 | 1.5 |
| accelerator TBBS | | | | | | | |
| Processing | (Basis) | Good | Good | Good | Good | Good | Good |
| performance | | | | | | | |
| (based on | | | | | | | |
| Comparative | | | | | | | |
| Example 14) | | | | | | | |
| Rubber hardness | 62 | 60 | 61 | 64 | 65 | 65 | 64 |
| Breaking strength | 26.7 | 26.1 | 27.0 | 28.5 | 29.1 | 28.8 | 28.4 |
| (MPa) | | | | | | | |
| Elongation at | 460 | 480 | 470 | 470 | 470 | 460 | 480 |
| break (%) | | | | | | | |
| Flex fatigue | (Basis) | Good | Good | Good | Good | Good | Good |
| performance | | | | | | | |
| (based on | | | | | | | |
| Comparative | | | | | | | |
| Example 14) | | | | | | | |
| tan δ | 100 | 113 | 110 | 96 | 98 | 102 | 100 |

As is apparent from the results of Table 3, it is apparent that, in the vulcanized rubbers of the rubber compositions for tire according to Examples 10 to 13, the elastic modulus, flex fatigue performance and fracture resistance characteristics are improved in good balance and also the low heat generation performance is improved. On the other hand, in the vulcanized rubber of the rubber composition containing a rosin resin blended therein according to Comparative Example 15, the low heat generation performance deteriorated. Also in the vulcanized rubber of the rubber composition containing a processing aid blended therein according to Comparative Example 16, the low heat generation performance deteriorated.

TABLE 4

| | | | | Specific | | Flatness index | | |
|---|---|---|---|---|---|---|---|---|
| | | | Kind of | surface | Structure | Height | Angle of | Mohs' |
| | Product name | Manufacturer | mineral | area (BET5) | (DBP/BET5) | (H) | repose | hardness |
| Inorganic filler (A) | MISTRON VAPOR | NIHON MISTRON CO., | Talc | 13.4 | 3.7 | 35 | 44 | 1 |
| | RE | LTD. | | | | | | |
| Inorganic filler (B) | P-6 | Nippon Talc Co., Ltd. | Talc | 10.5 | 4.3 | 33 | 44 | 1 |
| Inorganic filler (C) | SW | Nippon Talc Co., Ltd. | Talc | 5.5 | 8.0 | 28 | 42 | 1 |
| Inorganic filler (D) | HAR | NIHON MISTRON CO., | Talc | 20 | 2.5 | 25 | 36 | 1 |
| | | LTD. | | | | | | |
| Inorganic filler (E) | HAKUENKA CC | Shiraishi Kogyo | Calcium | 25 | 1.4 | 26 | 39 | 3-4 |
| | | Kaisha, Ltd. | carbonate | | | | | |
| Inorganic filler (F) | Hard Clay | Shiraishi Kogyo | Clay | 22 | 1.9 | 30 | 37 | 2 |
| | | Kaisha, Ltd. | | | | | | |

Next, regarding the rubber composition for tire tread according to the present invention, examples, which specifically illustrate the effect and constitution of the present invention, will be described below. Evaluation items in the examples were evaluated under the below-mentioned evaluation conditions, using rubber samples obtained by heating the respective compositions at 150° C. for 30 minutes, followed by vulcanization.

### (7) Rubber Hardness

In accordance with JIS K6253, rubber hardness (durometer type A) at 23° C. was evaluated. The evaluation results are shown by indexes, assuming the measured value of Comparative Example 1 to be 100. It means that the larger the numerical value, the more the hardness is higher.

### (8) Breaking Strength (Fracture Resistance Characteristics)

In accordance with JIS K6251, a sample was made using dumbbell No. 3 and a tensile test was carried out. The breaking strength (MPa) at the time of breakage of the sample was measured. The evaluation results are shown by indexes, assuming the measured value of Comparative Example 17 to be 100. It means that the larger the numerical value, the more fracture resistance characteristics are satisfactory.

### (9) Elongation at Break (%) (Cut/Chipping Performance)

In accordance with JIS K6251, a sample was made using dumbbell No. 3 and a tensile test was carried out. The elongation at break (%) at the time of breakage of the sample was measured. The evaluation results are shown by indexes, assuming the measured value of Comparative Example 17 to be 100. It means that the larger the numerical value, the more cut/chipping performance is satisfactory.

### (10) Abrasion Performance

In accordance with JIS K6264, the evaluation was carried out based on the results measured at a slip ratio of 30%, an applied load of 40 N and a sand falling rate of 20 g/minute. The evaluation results are shown by indexes, assuming the measured value of Comparative Example 17 to be 100. It means that the larger the numerical value, the more the abrasion performance is satisfactory.

### (11) tan δ (Low Heat Generation Performance)

Using a viscoelastic spectrometer manufactured by UBM, the evaluation was carried out based on the tan δ value measured at an initial strain of 15%, a dynamic strain of ±2.5%, a frequency of 10 Hz and a temperature of 60° C. It means that the smaller the numerical value, the more low heat generation performance is excellent.

### (Preparation of Rubber Composition)

According to the formulations shown in Table 5 and Table 6, rubber compositions of Example 14 to 23 and Comparative Example 17 to 23 were blended and then kneaded using a conventional Banbury mixer to prepare rubber compositions. The respective compound agents described in Table 5 and Table 6 are shown below (in Table 5 and Table 6, the amount of each compound agent blended is shown by the number of parts by mass based on 100 parts by mass of the rubber component). The angle of repose, height (H) (height (H) measured by the “method of measuring the angle of repose and height (H) of an inorganic filler), specific surface area (BET5), degree of development of structure ((DBP)/(BET5)) and Mohs' hardness of the following inorganic fillers (A) to (F) are the same as those shown in Table 4.

### (1) Rubber Component

Natural rubber (NR) “RSS#3”

Polystyrene-butadiene rubber (SBR-(1)) “JSR1502 (styrene content of 23.5% by mass, vinyl bond content of butadiene moiety of 18% by mass, cis content of 13% by mass)”, manufactured by JSR Corporation

Polystyrene-butadiene rubber (SBR-(2)) “Tufdene 1000 (styrene content of 18% by mass, vinyl bond content of butadiene moiety of 13% by mass, cis content of 35% by mass)”, manufactured by Asahi Kasei Corporation

Polybutadiene rubber (BR) “BR150L (terminal-unmodified product, cis-1,4 content of 98%, mass average molecular mass Mw=520,000)”, manufactured by Ube Industries, Ltd.

### (m) Carbon Black

Carbon black (SAF) “SEAST 9”, manufactured by TOKAI CARBON CO., LTD.

### (n) Inorganic Filler

Inorganic filler (A) “MISTRON VAPOR RE”, manufactured by NIHON MISTRON CO., LTD.

Inorganic filler (B) “P-6”, manufactured by Nippon Talc Co., Ltd.

Inorganic filler (C) “SW”, manufactured by Nippon Talc Co., Ltd.

Inorganic filler (D) “HAR”, manufactured by NIHON MISTRON CO., LTD.

Inorganic filler (E) “HAKUENKA CC”, manufactured by Shiraishi Kogyo Kaisha, Ltd.

Inorganic filler (F) “Hard Clay”, manufactured by Shiraishi Kogyo Kaisha, Ltd.

(o) Zinc oxide “Zinc White No. 1”, manufactured by MITSUI MINING & SMELTING., LTD.
(p) Stearic acid “Beads Stearic Acid”, manufactured by NOF CORPORATION
(q) Anti-aging agent “ANTIGEN 6C”, manufactured by Sumitomo Chemical Co., Ltd.
(r) Vulcanization accelerator “SANCELER CM-G”, manufactured by SANSHIN CHEMICAL INDUSTRY CO., LTD.
(s) Sulfur, manufactured by TSURUMI CHEMICAL INDUSTRY CO., LTD.

TABLE 5

| | Example | Example | Example | Example | Example | Example | Example | Example | Example | Example |
|---|---|---|---|---|---|---|---|---|---|---|
| | 14 | 15 | 16 | 17 | 18 | 19 | 20 | 21 | 22 | 23 |
| NR | 80 | 80 | 80 | 80 | 80 | 80 | 80 | 60 | 60 | 70 |
| SBR - (1) | 20 | 20 | 20 | — | — | — | — | 20 | — | 15 |
| SBR - (2) | — | — | — | 20 | 20 | 20 | 20 | 20 | 40 | — |
| BR | — | — | — | — | — | — | — | — | — | 15 |
| Carbon black | 50 | 40 | 60 | 50 | 50 | 50 | 40 | 50 | 50 | 50 |
| Inorganic filler (A) | 5 | 5 | 5 | 1 | 30 | — | — | 5 | 5 | 5 |
| Inorganic filler (B) | — | — | — | — | — | 5 | 10 | — | — | — |
| Inorganic filler (C) | — | — | — | — | — | — | — | — | — | — |
| Inorganic filler (D) | — | — | — | — | — | — | — | — | — | — |
| Inorganic filler (E) | — | — | — | — | — | — | — | — | — | — |
| Inorganic filler (F) | — | — | — | — | — | — | — | — | — | — |
| Zinc oxide | 3 | 3 | 3 | 3 | 3 | 3 | 3 | 3 | 3 | 3 |
| Stearic acid | 1 | 1 | 1 | 1 | 1 | 1 | 1 | 1 | 1 | 1 |
| Anti-aging agent | 1 | 1 | 1 | 1 | 1 | 1 | 1 | 1 | 1 | 1 |
| Vulcanization | 1 | 1 | 1 | 1 | 1 | 1 | 1 | 1 | 1 | 1 |
| accelerator | | | | | | | | | | |
| Powdered sulfur | 2 | 2 | 2 | 2 | 2 | 2 | 2 | 2 | 2 | 2 |
| hardness (°) | 103 | 100 | 106 | 101 | 105 | 103 | 102 | 104 | 104 | 103 |
| Breaking strength | 106 | 98 | 113 | 102 | 105 | 105 | 99 | 107 | 107 | 105 |
| Elongation at break | 101 | 105 | 96 | 100 | 99 | 100 | 105 | 100 | 101 | 102 |
| Low heat generation | 0.147 | 0.128 | 0.162 | 0.139 | 0.144 | 0.140 | 0.124 | 0.153 | 0.157 | 0.133 |
| performance | | | | | | | | | | |
| Abrasion performance | 101 | 93 | 110 | 100 | 104 | 101 | 95 | 103 | 105 | 106 |

TABLE 6

| | Comparative | Comparative | Comparative | Comparative | Comparative | Comparative | Comparative |
|---|---|---|---|---|---|---|---|
| | Example 17 | Example 18 | Example 19 | Example 20 | Example 21 | Example 22 | Example 23 |
| NR | 80 | 80 | 80 | 80 | 80 | 80 | 10 |
| SBR - (1) | 20 | 20 | 20 | 20 | 20 | 20 | 30 |
| SBR - (2) | — | — | — | — | — | — | — |
| BR | — | — | — | — | — | — | 60 |
| Carbon black | 50 | 50 | 50 | 50 | 50 | 50 | 50 |
| Inorganic filler (A) | | 40 | — | — | — | — | 5 |
| Inorganic filler (B) | — | — | — | — | — | — | — |
| Inorganic filler (C) | — | — | 5 | — | — | — | — |
| Inorganic filler (D) | — | — | — | 5 | — | — | — |
| Inorganic filler (E) | — | — | — | — | 5 | — | — |
| Inorganic filler (F) | — | — | — | — | — | 5 | 5 |
| Zinc oxide | 3 | 3 | 3 | 3 | 3 | 3 | 3 |
| Stearic acid | 1 | 1 | 1 | 1 | 1 | 1 | 1 |
| Anti-aging agent | 1 | 1 | 1 | 1 | 1 | 1 | 1 |
| Vulcanization | 1 | 1 | 1 | 1 | 1 | 1 | 1 |
| accelerator | | | | | | | |
| Powdered sulfur | 2 | 2 | 2 | 2 | 2 | 2 | 2 |
| hardness (°) | 100 | 106 | 101 | 103 | 101 | 103 | 97 |
| Breaking strength | 100 | 102 | 98 | 96 | 93 | 94 | 91 |
| Elongation at break | 100 | 95 | 94 | 92 | 93 | 94 | 94 |
| Low heat generation | 0.148 | 0.154 | 0.148 | 0.149 | 0.163 | 0.153 | 158.000 |
| performance | | | | | | | |
| Abrasion performance | 100 | 104 | 100 | 98 | 101 | 99 | 109 |

As is apparent from the results of Table 5, it is apparent that, the vulcanized rubbers of the rubber compositions according to Examples 14 to 23 have high rubber hardness and high elastic modulus, and the cut/chipping performance, fracture resistance characteristics and abrasion performance are improved in good balance and also the low heat generation performance is improved. On the other hand, as is apparent from the results of Table 6, it is apparent that, in the vulcanized rubber of the rubber composition according to Comparative Example 18, the cut/chipping performance deteriorates since the amount of the inorganic filler blended is large. It is apparent that, in the vulcanized rubber of the rubber composition according to Comparative Example 19, the cut/chipping performance deteriorates since talc having small BET5 and a large particle diameter is used and, also in the vulcanized rubber of the rubber composition using high flatness talc according to Comparative Example 20, the cut/chipping performance and fracture resistance characteristics deteriorate. It is apparent that, in the vulcanized rubber of the rubber composition according to Comparative Example 21, the cut/chipping performance, fracture resistance characteristics and low heat generation performance deteriorate since calcium carbonate having high Mohs' hardness is used, and in the vulcanized rubber of the rubber composition according to Comparative Example 22, the cut/chipping performance and fracture resistance characteristics deteriorate since high flatness clay is used. It is apparent that, in the vulcanized rubber of the rubber composition according to Comparative Example 23, the cut/chipping performance and fracture resistance characteristics deteriorate since the rubber component has a small content of a natural rubber.

What is claimed is:

1. A rubber composition for tire, comprising at least a rubber component and an inorganic filler,
wherein the inorganic filler has an angle of repose of 40 degrees or more, a Mohs' hardness of 2.0 or less, a BET specific surface area (BET5)(m²/g) of 10 m²/g or more, and a ratio (DBP)/(BET5) of the amount (ml/100 g) of dibutyl phthalate (DBP) absorbed to the BET specific surface area (BET5) (m²/g) of 2.0 or more, and
wherein the content of the inorganic filler is from 0.5 to 50 parts by mass based on 100 parts by mass of the rubber component.

2. The rubber composition for tire according to claim 1, wherein the rubber component contains 30 to 90 parts by mass of a natural rubber or a polyisoprene rubber, 10 to 70 parts by mass a polystyrene-butadiene rubber, and 0 to 60 parts by mass of a polybutadiene rubber, in 100 parts by mass of the rubber component.

3. The rubber composition for tire according to claim 1, wherein the inorganic filler is talc, and the content thereof is from 3 to 30 parts by mass based on the 100 parts by mass of the rubber component.

4. The rubber composition for tire according to claim 2, wherein the inorganic filler is talc, and the content thereof is from 3 to 30 parts by mass based on the 100 parts by mass of the rubber component.

5. The rubber composition for tire according to claim 1, further comprising a reinforcing filler comprised of at least one kind of carbon black and silica, wherein the content of the inorganic filler is less than that of the reinforcing filler.

6. The rubber composition for tire according to claim 2, further comprising a reinforcing filler comprised of at least one kind of carbon black and silica, wherein the content of the inorganic filler is less than that of the reinforcing filler.

7. The rubber composition for tire according to claim 3, further comprising a reinforcing filler comprised of at least one kind of carbon black and silica, wherein the content of the inorganic filler is less than that of the reinforcing filler.

8. The rubber composition for tire according to claim 1, wherein the content of the reinforcing filler is from 30 to 150 parts by mass based on 100 parts by mass of the rubber component.

9. The rubber composition for tire according to claim 2, wherein the content of the reinforcing filler is from 30 to 150 parts by mass based on 100 parts by mass of the rubber component.

10. The rubber composition for tire according to claim 3, wherein the content of the reinforcing filler is from 30 to 150 parts by mass based on 100 parts by mass of the rubber component.

11. The rubber composition for tire according to claim 5, wherein the content of the reinforcing filler is from 30 to 150 parts by mass based on 100 parts by mass of the rubber component.

12. A pneumatic tire using the rubber composition for tire according to claim 1.

13. A pneumatic tire using the rubber composition for tire according to claim 2 in a tire tread.
